(19) United States
(12) Patent Application Publication
(10) Pub. No.: US 2026/0313571 A1
(43) Pub. Date: Oct. 8, 2026

(54) METHOD AND APPARATUS FOR LATENCY ALIGNMENT IN DEVICE COLLABORATIVE COMMUNICATIONS

(71) Applicant: MEDIATEK INC., Hsinchu City (TW)

(72) Inventors: Wei-Kai CHANG, Hsinchu City (TW); Lung-Sheng TSAI, Hsinchu City (TW)

(21) Appl. No.: 19/482,377

(22) PCT Filed: Feb. 28, 2024
(86) PCT No.: PCT/CN2024/078981

§ 371 Date: Nov. 7, 2025

Related U.S. Application Data
(60) Provisional application No. 63/504,224, filed on May 25, 2023.

(51) Int. Cl. H04W 56/00; H04B 7/155; H04B 7/185

(52) U.S. Cl. CPC H04W 56/002; H04B 7/15542; H04B 7/18513

(57) ABSTRACT

Examples pertaining to latency alignment in device collaborative communications are described. A collaborating communication apparatus obtains information regarding a latency corresponding to a relay operation to relay a radio frequency (RF) signal to a primary communication apparatus or to a network node and provides the information regarding the latency to the primary communication apparatus to facilitate latency alignment in device collaborative communications among the primary communication apparatus, the collaborating communication apparatus and the network node.

### CROSS REFERENCE TO RELATED PATENT APPLICATION(S)

The present disclosure is part of a non-provisional application claiming the priority benefit of U.S. Patent Application No. 63/504,224, filed 25 May 2023, the content of which herein being incorporated by reference in its entirety.

### TECHNICAL FIELD

The present disclosure is generally related to mobile communications and, more particularly, to latency alignment in device collaborative communications.

### BACKGROUND

Unless otherwise indicated herein, approaches described in this section are not prior art to the claims listed below and are not admitted as prior art by inclusion in this section.

Massive multiple-input multiple-output (MIMO) technology plays a crucial role in boosting spectral efficiency and signal robustness in fifth generation (5G) New Radio (NR). With the breakthrough of practical antenna systems, accommodating large numbers of digital antenna ports at a network node has become feasible from an implementation standpoint.

Although the MIMO enhancement has been achieved at the network side, physical hardware limitation at the user equipment (UE) side is still a bottleneck for MIMO gain improvement.

Accordingly, device collaborative communications to improve the overall MIMO performance at the UE side and corresponding latency alignment in device collaborative communications becomes important issues for the newly developed wireless communication network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to latency alignment in uplink and downlink transmissions with respect to a communication apparatus (e.g., a user equipment (UE), a wearable device or others) communicating with a network apparatus (e.g., a network node or a base station (BS), such as a next generation Node B (gNB)) in device collaborative communications.

In one aspect, a method may involve a collaborating communication apparatus obtaining information regarding a latency corresponding to a relay operation to relay a radio frequency (RF) signal to a primary communication apparatus or to a network node and providing the information regarding the latency to the primary communication apparatus.

In one aspect, a method may involve a primary communication apparatus obtaining information regarding an uplink processing delay of a collaborating communication apparatus, transmitting a first RF signal on a first time-frequency resource to the collaborating communication apparatus and transmitting a second RF signal on a second time-frequency resource to a network node. An uplink latency of the transmitting of the second RF signal on the second time-frequency resource with respect to the transmitting of the first RF signal on the first time-frequency resource is determined based on the uplink processing delay.

In one aspect, a method may involve a primary communication apparatus obtaining information regarding a downlink processing delay of a collaborating communication apparatus and determining a downlink latency based on the downlink processing delay. The method may further involve the primary communication apparatus receiving a first RF signal on a first time-frequency resource from a network node and determining a first frame boundary associated with the first RF signal. The first RF signal carries baseband data. The method may further involve the primary communication apparatus receiving a second RF signal on a second time-frequency resource from the collaborating communication apparatus and determining a second frame boundary associated with the second RF signal based on the first frame boundary and the downlink latency.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a mobile communications network in accordance with implementations of the present disclosure.

FIG. 2 is a diagram depicting an example scenario of diversity augmentation based on device collaboration in accordance with implementations of the present disclosure.

FIG. 3 is a diagram depicting an example scenario of rank augmentation based on device collaboration in accordance with implementations of the present disclosure.

FIG. 4 is a diagram depicting an example scenario of transceiving capability augmentation based on device collaboration in accordance with implementations of the present disclosure.

FIG. 5 is a diagram depicting an example communication system having an example communication apparatus, an example network apparatus and an example relay apparatus in accordance with an implementation of the present disclosure.

FIG. 6 is a diagram depicting an example process in accordance with an implementation of the present disclosure.

FIG. 7 is a diagram depicting another example process in accordance with an implementation of the present disclosure.

FIG. 8 is a diagram depicting yet another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to latency alignment in device collaborative communications. According to the present disclosure, a number of possible solutions may be implemented separately or jointly. That is, although these possible solutions may be described below separately, two or more of these possible solutions may be implemented in one combination or another.

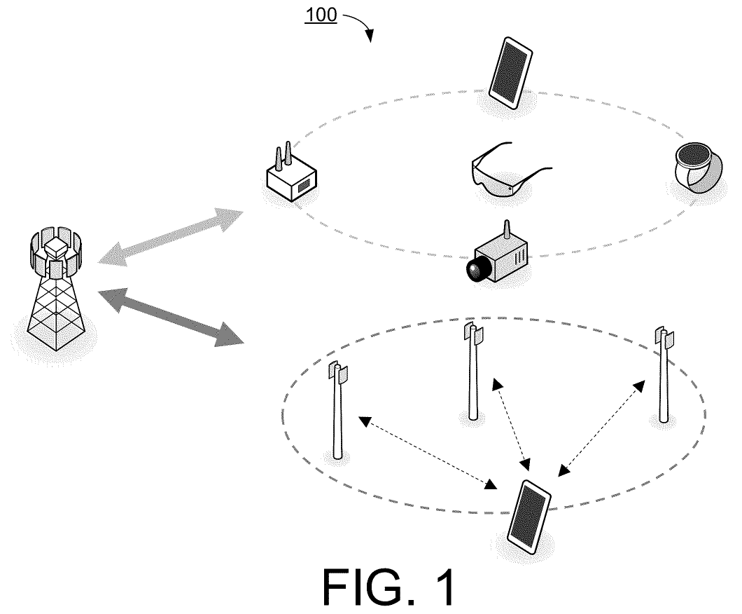

FIG. 1 illustrates an example scenario 100 of a mobile communications network to implement device collaboration in accordance with implementations of the present disclosure. A personal area network (PAN) may support extended reality (XR)-like services, such as XR glasses with a mobile phone or a customer premises equipment (CPE). A public network may comprise one or more repeaters and mobile phones. In some implementations, at least one device may be a collaborating communication apparatus to facilitate augmentation in transceiving capability (e.g., antenna capability, diversity, rank, or others) of a primary communication apparatus in the mobile communications network.

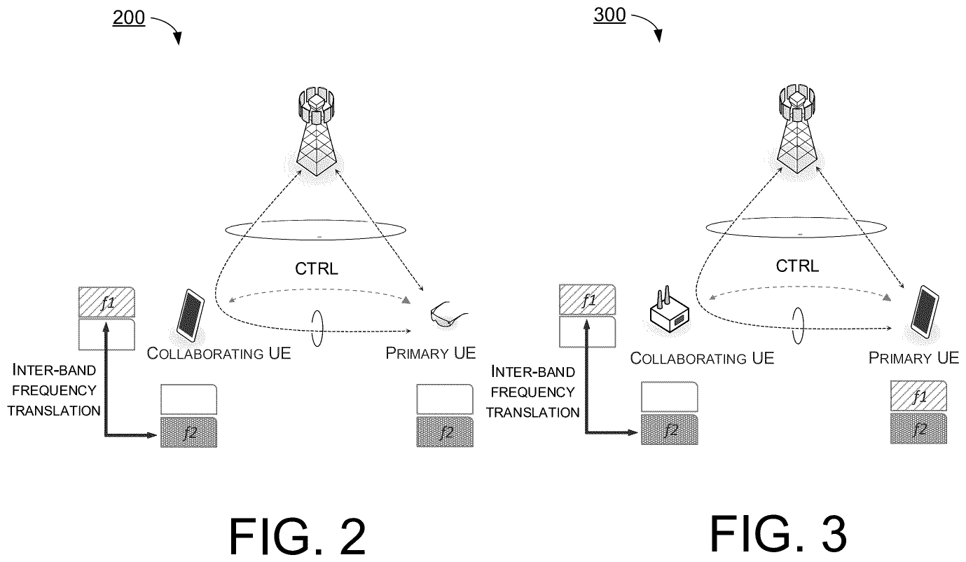

FIG. 2 illustrates an example scenario 200 of diversity augmentation based on device collaboration in accordance with implementations of the present disclosure. A high-capability device (e.g., a smartphone) may serve as a proxy to provide a good-quality data path for a low-capability device (e.g., XR glasses). In this device collaboration scenario, the high-capability device may be a collaborating communication apparatus or a collaborating UE and the low-capability device may be a primary communication apparatus or a primary UE. A device-control path CTRL may be established between the primary UE and the collaborating UE to exchange critical information, including channel state information (CSI), repeater-mode enabling, power control etc.

The collaborating UE may communicate with a network node (such as a satellite, a base station or a network apparatus in the mobile communications network) in a first frequency band f1 and communicate with the primary UE in a second frequency band f2. The collaborating UE may perform inter-band frequency translation to shift the radio frequency (RF) carrier of the received signal from the first frequency band f1 to the second frequency band f2 and vice versa. This device collaboration is applicable to both uplink and downlink transmissions.

Compared to smartphones, a wearable device typically has less capability in terms of MIMO processing capability, number of transmitting (Tx) or receiving (Rx) antennas, carrier aggregation (CA) capability, etc. FIG. 2 illustrates that the collaborating UE (e.g., a 4Rx smartphone) as an intermediate node works together with a 2Rx wearable device with 1 component carrier (CC) capability. The smartphone may act as an advanced amplify and forward (AF) repeater with better Rx beamforming capability (i.e., more receive antennas), and may purify signal quality by rejecting interference coming from un-expected directions, and forward processed signal to the low-capability wearable device.

FIG. 3 illustrates an example scenario 300 of rank augmentation based on device collaboration in accordance with implementations of the present disclosure. One smartphone and one collaborating device (such as a relay device, another smartphone, an indoor CPE, or others) collaborate to receive, at the smartphone, a resulting high-rank data signal transmitted from the network node (such as a satellite, a base station or a network apparatus in the mobile communications network).

In this device collaboration scenario, the smartphone may be a primary communication apparatus or a primary UE and the aforementioned collaborating device may be a collaborating communication apparatus or a collaborating UE. The primary UE may communicate with the network node in a first frequency band f1 and communicate with the collaborating UE in a second frequency band f2. The collaborating UE may communicate with the network node in the first frequency band f1 as the primary UE does, and communicate with the primary UE in the second frequency band f2. The collaborating UE may perform inter-band frequency translation to shift the RF carrier of the received signal from the first frequency band f1 to the second frequency band f2 and vice versa. This device collaboration is also applicable to both uplink and downlink transmissions.

A device-control path CTRL may be established between the primary UE and the collaborating UE to exchange critical information, including CSI, repeater-mode enabling, power control etc. The primary UE utilizes its CA capability to receive signals directed from the base-station and the collaborating UE simultaneously in two bands f1 and f2 and processes the received signals jointly, as if having two sets of Rx antennas. The network node transmits a signal in frequency band f1 to an end-device that appears to be equipped with two sets of Rx antennas in a single band, so the rank of the end-to-end MIMO channel rank is doubled.

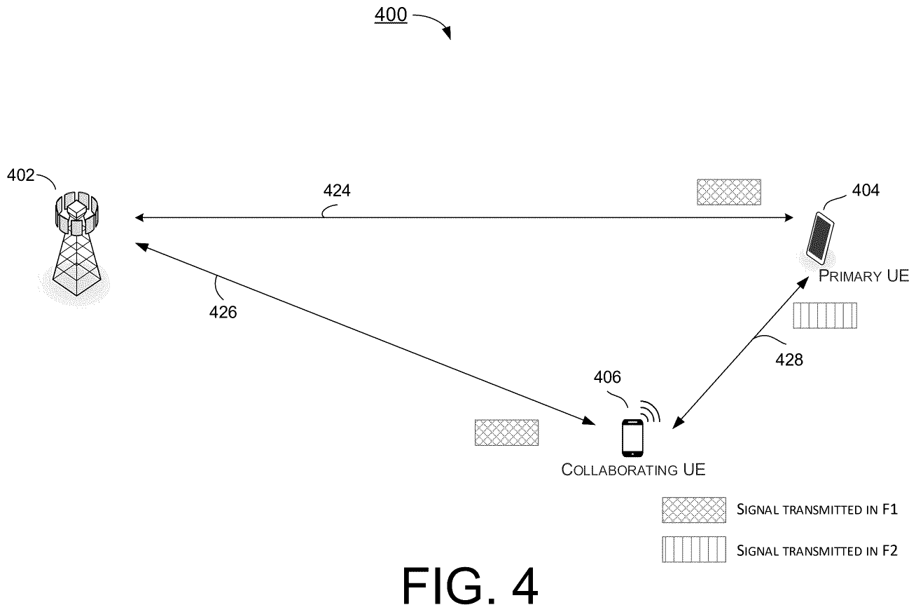

FIG. 4 illustrates an example scenario 400 of transceiving capability augmentation based on device collaboration in accordance with implementations of the present disclosure. In this example, a collaborating communication apparatus (denoted as collaborating UE 406 in FIG. 4) may be placed near a primary communication apparatus (denoted as primary UE 404 in FIG. 4) or placed between a network node 402 (such as a satellite, a base station or a network apparatus in the mobile communications network) and the primary UE 404.

The primary UE 404 may communicate with the network node 402 in a first frequency band f1 and communicate with the collaborating UE 406 in a second frequency band f2. The collaborating UE 406 may communicate with the network node 402 in the first frequency band f1 as the primary UE 404 and communicate with the primary UE 404 in the second frequency band f2. The collaborating UE 406 may perform inter-band frequency translation to shift the RF carrier of the received signal from the first frequency band f1 to the second frequency band f2 and vice versa. This device collaboration is also applicable to both uplink and downlink transmissions.

In some implementations, the primary UE 404 may simultaneously or substantially simultaneously (e.g., with a predetermined uplink or downlink latency) transmit signals on two different time-frequency resources or in two different frequency bands f1 and f2.

In some implementations, the primary UE 404 may comprise multiple physical antennas, and the physical antennas may be shared on the two different time-frequency resources or the two different frequency bands to reduce chip area cost of the primary UE 404. Note that the primary UE 404 may also use two different groups of antennas to respectively transmit signals on two different time-frequency resources or in two different frequency bands, and the invention is not limited to any type of implementation.

In one example, the primary UE 404 may have 4 physical antennas (i.e., physical antennas 1 to 4) and may have 4 layers of data (i.e., layers 1 to 4) to be transmitted. Further, each layer of data corresponds to an antenna port. In a first configuration, the primary UE 404 maps a particular layer to a particular physical antenna. For example, the layer 1 data is transmitted through the physical antenna 1, the layer 2 data is transmitted through the physical antenna 2, and so on. This may be referred to as a non-coherent mode. In a second configuration, at the primary UE 404, at least one particular layer is mapped to at least two physical antennas and at least one physical antenna is not mapped with at least one layer of the 4 layers of data. For example, the layer 1 data is transmitted through the physical antenna 1 and the physical antenna 2, the layer 2 data is transmitted through the physical antenna 3 and the physical antenna 4, and so on. This may be referred to as a partial-coherent mode. In a third configuration, each layer of data is mapped to all physical antennas. This is referred to as a full-coherent mode.

The primary UE 404 may transmit a first signal to the network node 402 through the channel 424 (which may be regarded as a direct path or direct link). The primary UE 404 may transmit a second signal to the collaborating UE 406 through the channel 428, where the second signal may be then transmitted to the network node 402 through the channel 426. The channels 428 and 426 may be regarded as an indirect path or indirect link. The primary UE 404 may apply a first precoder on the first signal and apply a second precoder on the second signal. As an example, the primary UE 404 may map the first signal to a first group of physical antennas (e.g., comprising two physical antennas) to generate two superimposed signals, and map the second signal to a second group of physical antennas (e.g., comprising two physical antennas) to generate two superimposed signals.

Further, the primary UE 404 may mix the superimposed signals with the corresponding RF carriers and transmit the resulting RF signals at the corresponding group of physical antennas.

For the direct path, the network node 402 may receive the RF signals from the primary UE 404 through the channel 424.

For the indirect path, the collaborating UE 406 may receive the RF signals from the primary UE 404 through the channel 428, and the network node 402 may receive the RF signals from the collaborating UE 406 through the channel 426. The collaborating UE 406 may relay or forward the received signals, with some necessary processing such as, but not limited to, amplification or linear combination, to the network node 402.

In some implementations, the frequency translation may be performed by the collaborating UE 406 in either an analog domain or a digital domain. In some implementations, the collaborating UE 406 may perform some digital baseband signal processing for frequency translation. As the digital baseband data path is involved, the latency for data processing in the collaborating UE 406 may increase. Therefore, latency alignment for uplink and/or downlink transmissions may be required in device collaborative communications.

In some implementations, the collaborating communication apparatus (e.g., a collaborating UE or a relay apparatus, such as the collaborating UE 406 shown in FIG. 4) may obtain its uplink processing delay (for example and without limitation, an internal latency or internal delay for frequency translation in an uplink direction or some necessary processing in the uplink direction) by design guarantee, factory calibration.

In some implementations, the collaborating communication apparatus may obtain its downlink processing delay (for example and without limitation, an internal latency or internal delay for frequency translation in a downlink direction or some necessary processing in the downlink direction) by design guarantee, factory calibration or on-the-fly calibration.

In some implementations, the uplink processing delay and/or the downlink processing delay may be estimated or determined by field try results or experimental results. In some implementations, the uplink processing delay and/or the downlink processing delay may be estimated or determined by the collaborating communication apparatus itself or by an external instrument.

In some implementations, the downlink processing delay or latency may be dynamically estimated, determined or adjusted by the collaborating communication apparatus or the primary communication apparatus via on-the-fly calibration. For example, the collaborating communication apparatus and/or the primary communication apparatus may determine or estimate the downlink latency or the downlink processing delay by using the reference signal transmitted by the network node.

In some implementations, the uplink processing delay or latency may be dynamically estimated, determined or adjusted by the collaborating communication apparatus or the network node via on-the-fly calibration. For example, the collaborating communication apparatus and/or the network node may perform the on-the-fly calibration on the uplink latency or the uplink processing delay by using the signal received from by the primary communication apparatus. For the case when the uplink latency or the uplink processing delay is determined or estimated by the network node, the network node may further provide information regarding the uplink latency or the uplink processing delay to the primary communication apparatus or the collaborating communication apparatus.

In some implementations, the collaborating communication apparatus may obtain information regarding a latency (for example and without limitation, the aforementioned internal latency or internal delay for frequency translation or some necessary processing in either the uplink direction or the downlink direction) corresponding to a relay operation to relay a radio frequency (RF) signal to a primary communication apparatus (e.g., a primary communication apparatus or a primary UE, such as the primary UE 404 shown in FIG. 4) or to a network node (such as a satellite, a base station or a network apparatus in the mobile communications network, such as the network node 402 shown in FIG. 4), and provide the information regarding the latency to the primary communication apparatus.

In some implementations, in the downlink direction, the collaborating communication apparatus may receive M_{rdl} RF signals at M_{rdl} antennas on a first time-frequency resource from the network node and transmit M_{tdl} RF signals at M_{tdl} antennas on a second time-frequency to the primary communication apparatus. The M_{rdl} represents the number of the RX signal streams in the downlink direction (or the number of RX antennas) of the collaborating communication apparatus and the M_{rdl} RF signals carry a baseband data signal corresponding to L layers of data generated at the network node. In some implementations, the number M_{rdl} and the number L are positive integers and L is greater than M_{rdl}. The M_{tdl} represents the number of the TX signal streams in the downlink direction (or the number of TX antennas) of the collaborating communication apparatus and the M_{tdl} RF signals carry the L layers of data.

In the uplink direction, the collaborating communication apparatus may receive Mᵣᵤₗ RF signals at Mᵣᵤₗ antennas on a first time-frequency from the primary communication apparatus and transmit Mₜᵤₗ RF signals at Mₜᵤₗ antennas on a second time-frequency resource to the network node. The Mᵣᵤₗ represents the number of the RX signal streams in the uplink direction (or the number of RX antennas) of the collaborating communication apparatus and Mᵣᵤₗ RF signals carry a baseband data signal corresponding to K layers of data generated at the primary communication apparatus. In some implementations, the number Mᵣᵤₗ and the number K are positive integers. The Mₜᵤₗ represents the number of the TX signal streams in the uplink direction (or the number of TX antennas) of the collaborating communication apparatus and the Mₜᵤₗ RF signals carry the K layers of data.

In some implementations, the relay operation may comprise amplifying and forwarding and may not comprise decoding the RF signal. In some implementations, the relay operation may be based on amplifying and forwarding without decoding the RF signal.

In some implementations, the information regarding the latency may be pre-stored in a memory of the collaborating communication apparatus.

In some implementations, the information regarding the latency may be provided to the primary communication apparatus via a control signal transmitted between the primary communication apparatus and the collaborating communication apparatus (e.g., via the aforementioned device-control path CTRL).

In some implementations, the information regarding the latency may comprise at least one of an uplink latency and a downlink latency. For uplink direction, the primary communication apparatus may utilize the uplink latency to implement timing advance on the signal stream transmitted to the collaborating communication apparatus. For downlink direction, the primary communication apparatus may utilize the downlink plink latency to estimate the frame boundary of the signal stream transmitted by the collaborating communication apparatus, to speed up the decoding of the signals received from different devices (e.g., the network node and the collaborating communication apparatus) in the primary communication apparatus.

In some implementations, the latency may comprise an uplink latency (e.g., an uplink latency D_{UL}), and the latency may be estimated or determined by the collaborating communication apparatus. More specifically, In some implementations, the collaborating communication apparatus may receive a first RF signal on a first time-frequency resource from the primary communication apparatus, transmit a second RF signal on a second time-frequency resource to the network node, and determine a time difference between the receiving of the first RF signal on the first time-frequency resource and the transmitting of the second RF signal on the second time-frequency resource as the uplink latency. In some implementations, the first RF signal may carry baseband data generated by the primary communication apparatus and the second RF signal is originated from the first RF signal.

In some implementations, for the signal processing in the uplink direction, the collaborating communication apparatus may translate the first RF signal from a first frequency band corresponding to the first time-frequency resource to a second frequency band corresponding to the second time-frequency resource to generate the second RF signal. In some implementations, the collaborating communication apparatus may perform linear combination on one or more first RF signals received from the primary communication apparatus to generate a linear combined signal and translate the linear combined signal from a first frequency band corresponding to the first time-frequency resource to a second frequency band corresponding to the second time-frequency resource to generate the second RF signal.

In some implementations, the first time-frequency resource and the second time-frequency resource do not overlap with each other in time domain and/or do not overlap with each other in frequency domain.

In some implementations, the latency may comprise a downlink latency (e.g., a downlink latency D_{DL}), and may be determined by the collaborating communication apparatus. More specifically, In some implementations, the collaborating communication apparatus may receive a first RF signal on a first time-frequency resource from the network node, transmit a second RF signal on a second time-frequency resource to the primary communication apparatus and determine a time difference between the receiving of the first RF signal on the first time-frequency resource and the transmitting of the second RF signal on the second time-frequency resource as the downlink latency. In some implementations, the first RF signal may carry baseband data generated by the network node and the second RF signal is originated from the first RF signal.

In some implementations, for the signal processing in the downlink direction, the collaborating communication apparatus may translate the first RF signal from a first frequency band corresponding to the first time-frequency resource to a second frequency band corresponding to the second time-frequency resource to generate the second RF signal. In some implementations, the collaborating communication apparatus may perform linear combination on one or more first RF signals received from the network node to generate a linear combined signal and translate the linear combined signal from a first frequency band corresponding to the first time-frequency resource to a second frequency band corresponding to the second time-frequency resource to generate the second RF signal.

In some implementations, the first time-frequency resource and the second time-frequency resource do not overlap with each other in time domain and/or do not overlap with each other in frequency domain.

In some implementations, the information regarding the uplink latency may be utilized by the primary communication apparatus to compensate for the uplink latency on the indirect path due to device collaboration. In some implementations, the information regarding the downlink latency may be utilized by the primary communication apparatus to determine the frame boundary associated with the signal received from the indirect path, reducing the computation complexity in frame boundary determination or timing alignment. The primary communication apparatus may align the frame boundary of the signal received from the indirect path to the frame boundary of the signal received from the direct path. When timing of the signals received from different paths are aligned, the primary communication apparatus may perform joint decoding on the signals, to achieve improvement in the overall MIMO performance.

More specifically, in some implementations regarding latency alignment in uplink transmission, the primary communication apparatus may obtain information regarding an uplink processing delay of the collaborating communication apparatus, transmit a first RF signal on a first time-frequency resource to the collaborating communication apparatus, and transmit a second RF signal on a second time-frequency resource to the network node. An uplink latency of the transmitting of the second RF signal on the second time-frequency resource with respect to the transmitting of the first RF signal on the first time-frequency resource may be determined based on the uplink processing delay.

In some implementations, the information regarding the uplink processing delay may be obtained from the collaborating communication apparatus or the network node.

In some implementations, the first RF signal and the second RF signal carry a first baseband data signal and a second baseband data signal respectively, and the first baseband data signal and the second data signal are to be or are supposed to be received by the network node in a same slot.

In some implementations, the first RF signal may be transmitted at a first time (e.g., t1), the second RF signal may be transmitted at a second time (e.g., t2), and wherein the first time is prior to the second time by the uplink latency or by a quantized value of the uplink latency (e.g., (t2-t1) equals to D_{UL} or a quantized value of D_{UL}, or t1 is a quantized value of (t2-D_{UL})).

In some implementations, the first time-frequency resource and the second time-frequency resource do not overlap with each other in time domain or do not overlap with each other in frequency domain.

In some implementations regarding latency alignment in downlink transmission, the primary communication apparatus may obtain information regarding a downlink processing delay of the collaborating communication apparatus and determine a downlink latency (e.g., the downlink latency D_{DL}) based on the downlink processing delay. The primary communication apparatus may receive a third RF signal on a third time-frequency resource from the network node and determine a first frame boundary associated with the third RF signal. The third RF signal carries baseband data generated by the network node. The primary communication apparatus may receive a fourth RF signal on a fourth time-frequency resource from the collaborating communication apparatus and determine a second frame boundary associated with the fourth RF signal based on the first frame boundary and the downlink latency.

In some implementations, the information regarding the downlink processing delay may be obtained from the collaborating communication apparatus or the network node.

In some implementations, the third time-frequency resource and the fourth time-frequency resource do not overlap with each other in time domain or do not overlap with each other in frequency domain.

### Illustrative Implementations

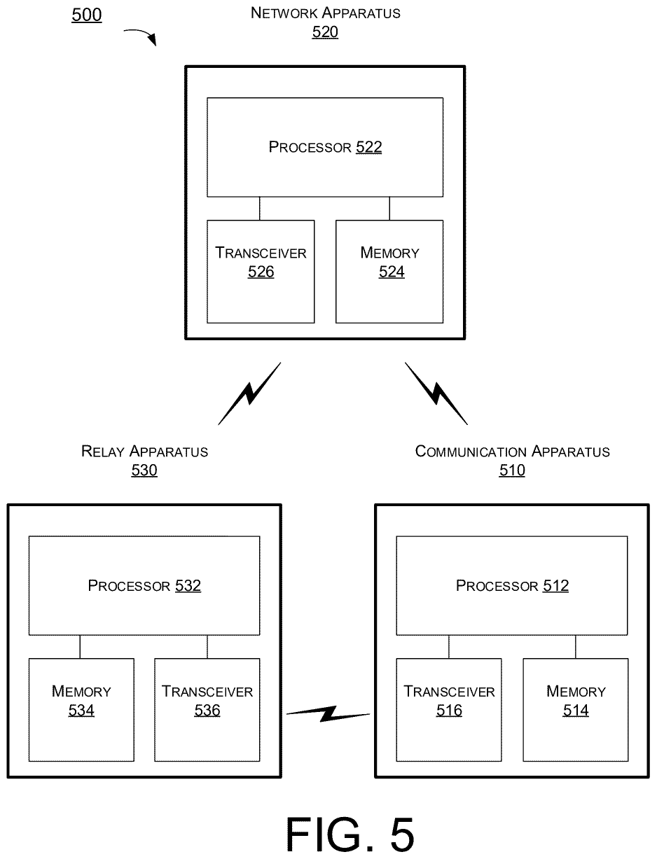

FIG. 5 illustrates an example communication system 500 having an example communication apparatus 510, an example network apparatus 520 and an example relay apparatus 530 in accordance with an implementation of the present disclosure. Each of the communication apparatus 510, the network apparatus 520 and the relay apparatus 530 may perform various functions to implement schemes, techniques, processes and methods described herein pertaining to latency alignment in device collaborative communications, including scenarios/schemes described above as well as the process 600, 700 and process 800 described below.

The communication apparatus 510 may be a part of an electronic apparatus, which may be a UE such as a portable or mobile apparatus, a wearable apparatus, a wireless communication apparatus or a computing apparatus. For instance, the communication apparatus 510 may be implemented in a smartphone, a smartwatch, a personal digital assistant, a digital camera, or a computing equipment such as a tablet computer, a laptop computer or a notebook computer. The communication apparatus 510 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 510 may be implemented in a smart thermostat, a smart fridge, a smart door lock, a wireless speaker or a home control center. Alternatively, the communication apparatus 510 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. The communication apparatus 510 may include at least some of those components shown in FIG. 5 such as a processor 512, for example. The communication apparatus 510 may further include one or more other components not pertinent to the proposed scheme of the present disclosure (e.g., internal power supply, display device and/or user interface device), and, thus, such component(s) of the communication apparatus 510 are neither shown in FIG. 5 nor described below in the interest of simplicity and brevity.

The network apparatus 520 may be a part of a network device, which may be a network node such as a satellite, a base station, a small cell, a router or a gateway. For instance, the network apparatus 520 may be implemented in an eNodeB in an LTE network, in a gNB in a 5G/NR, IoT, NB-IoT or IIoT network or in a satellite or base station in a 6G network. Alternatively, the network apparatus 520 may be implemented in the form of one or more IC chips such as, for example and without limitation, one or more single-core processors, one or more multi-core processors, or one or more RISC or CISC processors. The network apparatus 520 may include at least some of those components shown in FIG. 5 such as a processor 522, for example. The network apparatus 520 may further include one or more other components not pertinent to the proposed scheme of the present disclosure (e.g., internal power supply, display device and/or user interface device), and, thus, such component(s) of the network apparatus 520 are neither shown in FIG. 5 nor described below in the interest of simplicity and brevity.

The relay apparatus 530 may be a part of an electronic apparatus, which may be a UE such as a portable or mobile apparatus, a wearable apparatus, a wireless communication apparatus, a relay device, a CPE or a computing apparatus. For instance, the relay apparatus 530 may be implemented in a smartphone, a smartwatch, an XR glasses, a personal digital assistant, a digital camera, or a computing equipment such as a tablet computer, a laptop computer or a notebook computer. The relay apparatus 530 may also be a part of a machine type apparatus, which may be an IoT, NB-IoT, or IIoT apparatus such as an immobile or a stationary apparatus, a home apparatus, a wire communication apparatus or a computing apparatus. For instance, the relay apparatus 530 may be implemented in a smart thermostat, a smart fridge, a smart door lock, a wireless speaker or a home control center. Alternatively, the relay apparatus 530 may be implemented in the form of one or more IC chips such as, for example and without limitation, one or more single-core processors, one or more multi-core processors, one or more RISC processors, or one or more CISC processors. The relay apparatus 530 may include at least some of those components shown in FIG. 5 such as a processor 532, for example. The relay apparatus 530 may further include one or more other components not pertinent to the proposed scheme of the present disclosure (e.g., internal power supply, display device and/or user interface device), and, thus, such component(s) of the relay apparatus 530 are neither shown in FIG. 5 nor described below in the interest of simplicity and brevity.

In some implementations, the communication apparatus 510 may be a primary communication apparatus and the relay apparatus 530 may be a collaborating communication apparatus when performing device collaborative communications.

In one aspect, each of the processor 512, the processor 522 and the processor 532 may be implemented in the form of one or more single-core processors, one or more multi-core processors, or one or more CISC processors. That is, even though a singular term “a processor” is used herein to refer to the processor 512, the processor 522 and the processor 532, each of the processor 512, the processor 522 and the processor 532 may include multiple processors in some implementations and a single processor in other implementations in accordance with the present disclosure. In another aspect, each of the processor 512, the processor 522 and the processor 532 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of the processor 512, the processor 522 and the processor 532 is a special-purpose machine specifically designed, arranged and configured to perform specific tasks including autonomous reliability enhancements in a device (e.g., as represented by communication apparatus 510 or relay apparatus 530) and a network (e.g., as represented by network apparatus 520) in accordance with various implementations of the present disclosure.

In some implementations, the communication apparatus 510 may also include a transceiver 516 coupled to the processor 512 and capable of wirelessly transmitting and receiving data. In some implementations, the communication apparatus 510 may further include a memory 514 coupled to the processor 512 and capable of being accessed by the processor 512 and storing data therein. In some implementations, the network apparatus 520 may also include a transceiver 526 coupled to the processor 522 and capable of wirelessly transmitting and receiving data. In some implementations, the network apparatus 520 may have a plurality of physical antennas which associates with a plurality of antenna ports. In some implementations, the network apparatus 520 may further include a memory 524 coupled to processor 522 and capable of being accessed by the processor 522 and storing data therein. In some implementations, the relay apparatus 530 may also include a transceiver 536 coupled to the processor 532 and capable of wirelessly transmitting and receiving data. In some implementations, the relay apparatus 530 may further include a memory 534 coupled to the processor 532 and capable of being accessed by the processor 532 and storing data therein.

Accordingly, the communication apparatus 510, the network apparatus 520 and the relay apparatus 530 may wirelessly communicate with each other via the transceiver 516, the transceiver 526 and the transceiver 536, respectively. To aid better understanding, the following description of the operations, functionalities and capabilities of each of the communication apparatus 510, the network apparatus 520 and the relay apparatus 530 is provided in the context of a mobile communication environment in which the communication apparatus 510 is implemented in or as a primary communication apparatus or a primary UE, the network apparatus 520 is implemented in or as a network node or a network device and the relay apparatus 530 is implemented in or as a collaborating communication apparatus or a collaborating UE of a communication network supporting device collaborative communications.

In some implementations, with respect to uplink transmissions, the processor 512 of the communication apparatus 510 may obtain information regarding an uplink processing delay of a collaborating communication apparatus (e.g., the relay apparatus 530). The processor 512 may further transmit, via the transceiver 516, a first RF signal on a first time-frequency resource to the collaborating communication apparatus and transmit, via the transceiver 516, a second RF signal on a second time-frequency resource to a network node (e.g., the network apparatus 520). In some implementations, an uplink latency of the transmitting of the second RF signal on the second time-frequency resource with respect to the transmitting of the first RF signal on the first time-frequency resource may be determined based on the uplink processing delay.

In some implementations, the uplink latency may be set to the value of obtained uplink processing delay. In some implementations, the uplink latency may be set to a summation of a transmission time required from the primary communication apparatus to the collaborating communication apparatus and the obtained uplink processing delay.

In some implementations, the first RF signal and the second RF signal carry a first baseband data signal and a second baseband data signal respectively, and the first baseband data signal and the second data signal are to be or are supposed to be received by the network node in a same slot.

In some implementations, the first RF signal may be transmitted at a first time, the second RF signal may be transmitted at a second time, and the first time may be prior to the second time by the uplink latency or by a quantized value of the uplink latency.

In some implementations, the first time-frequency resource and the second time-frequency resource do not overlap with each other in time domain or do not overlap with each other in frequency domain.

In some implementations, with respect to downlink transmissions, the processor 512 of the communication apparatus 510 may obtain information regarding a downlink processing delay of the collaborating communication apparatus and determine a downlink latency based on the downlink processing delay. The processor 512 may further receive, via the transceiver 516, a first RF signal on a first time-frequency resource from the network node, and determine a first frame boundary associated with a signal derived from the first RF signal. The first RF signal may carry baseband data generated by the network node. The processor 512 may further receive, via the transceiver 516, a second RF signal on a second time-frequency resource from the collaborating communication apparatus and determine a second frame boundary associated with a signal derived from the second RF signal based on the first frame boundary and the downlink latency.

In some implementations, the first time-frequency resource and the second time-frequency resource do not overlap with each other in time domain or do not overlap with each other in frequency domain.

Regarding the operations of the relay apparatus 530, in some implementations, the processor 532 of the relay apparatus 530 may obtain information regarding a latency corresponding to a relay operation to relay a RF signal to a primary communication apparatus (e.g., the communication apparatus 510) or to a network node (e.g., the network apparatus 520) and provide the information regarding the latency to the primary communication apparatus.

In some implementations, the relay operation may comprise amplifying and forwarding and may not comprise decoding the RF signal. In some implementations, the relay operation may be based on amplifying and forwarding without decoding the RF signal.

In some implementations, the information regarding the latency may be pre-stored in the memory 534 of the relay apparatus 530.

In some implementations, the latency may comprise an uplink latency, and the processor 532 may receive, via the transceiver 536, a first RF signal on a first time-frequency resource from the primary communication apparatus, transmit, via the transceiver 536, a second RF signal on a second time-frequency resource to the network node and determine a time difference between the receiving of the first RF signal on the first time-frequency resource and the transmitting of the second RF signal on the second time-frequency resource as the uplink latency. In some implementations, the first RF signal may carry baseband data generated by the primary communication apparatus and the second RF signal is originated from the first RF signal.

In some implementations, the latency may comprise a downlink latency, and the processor 532 may receive, via the transceiver 536, a first RF signal on a first time-frequency resource from the network node, transmit, via the transceiver 536, a second RF signal on a second time-frequency resource to the primary communication apparatus and determine a time difference between the receiving of the first RF signal on the first time-frequency resource and the transmitting of the second RF signal on the second time-frequency resource as the downlink latency. In some implementations, the first RF signal may carry baseband data generated by the network node and the second RF signal is originated from the first RF signal.

In some implementations, in either uplink or downlink direction, the processor 532 may translate the first RF signal from a first frequency band corresponding to the first time-frequency resource to a second frequency band corresponding to the second time-frequency resource to generate the second RF signal.

In some implementations, in either uplink or downlink direction, the first time-frequency resource and the second time-frequency resource do not overlap with each other in time domain or do not overlap with each other in frequency domain.

### Illustrative Processes

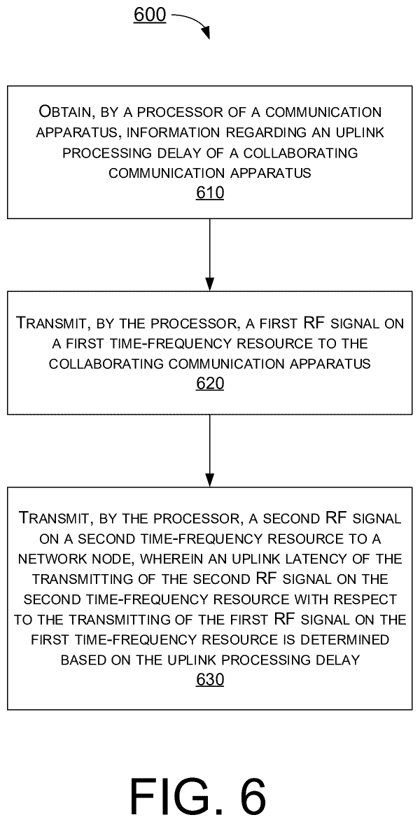

FIG. 6 illustrates an example process 600 in accordance with an implementation of the present disclosure. The process 600 may be an example implementation of above scenarios/schemes, whether partially or completely, with respect to latency alignment in device collaborative communications in accordance with the present disclosure. The process 600 may represent an aspect of implementation of features of the communication apparatus 510. The process 600 may include one or more operations, actions, or functions as illustrated by one or more of blocks 610, 620 and 630. Although illustrated as discrete blocks, various blocks of the process 600 may be divided into additional blocks, combined into fewer blocks, or eliminated, depending on the desired implementation. Moreover, the blocks of the process 600 may be executed in the order shown in FIG. 6 or, alternatively, in a different order. The process 600 may be implemented by the communication apparatus 510 or any suitable UE or machine type devices. Solely for illustrative purposes and without limitation, the process 600 is described below in the context of the communication apparatus 510. The process 600 may begin at block 610.

At 610, the process 600 may involve the processor 512 of the communication apparatus 510 obtaining information regarding an uplink processing delay of a collaborating communication apparatus (e.g., the relay apparatus 530). The process 600 may proceed from 610 to 620.

At 620, the process 600 may involve the processor 512 transmitting a first RF signal on a first time-frequency resource to the collaborating communication apparatus. The process 600 may proceed from 620 to 630.

At 630, the process 600 may involve the processor 512 transmitting a second RF signal on a second time-frequency resource to a network node (e.g., the network apparatus 520). An uplink latency of the transmitting of the second RF signal on the second time-frequency resource with respect to the transmitting of the first RF signal on the first time-frequency resource may be determined based on the uplink processing delay.

In some implementations, the first RF signal and the second RF signal carry a first baseband data signal and a second baseband data signal respectively, and the first baseband data signal and the second data signal are to be or are supposed to be received by the network node in a same slot.

In some implementations, the first RF signal may be transmitted at a first time, the second RF signal may be transmitted at a second time, and wherein the first time is prior to the second time by the uplink latency or by a quantized value of the uplink latency.

In some implementations, the first time-frequency resource and the second time-frequency resource may not overlap with each other in time domain or in frequency domain.

In some implementations, the process 600 may involve the processor 512 obtaining information regarding a downlink processing delay of the collaborating communication apparatus and determining a downlink latency based on the downlink processing delay. The process 600 may involve the processor 512 receiving a third RF signal on a third time-frequency resource from the network node and determining a first frame boundary associated with the third RF signal, wherein the third RF signal carries baseband data. The process 600 may involve the processor 512 receiving a fourth RF signal on a fourth time-frequency resource from the collaborating communication apparatus and determining a second frame boundary associated with the fourth RF signal based on the first frame boundary and the downlink latency.

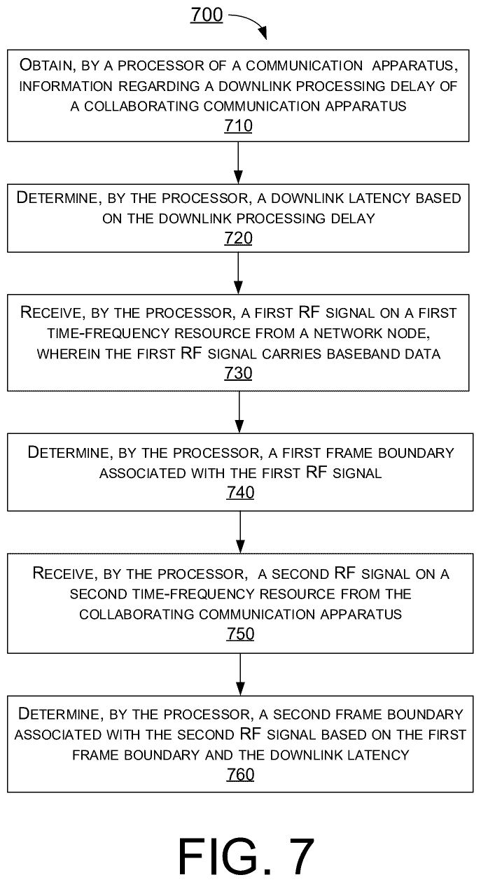

FIG. 7 depicting another example process 700 in accordance with an implementation of the present disclosure. The process 700 may be an example implementation of above scenarios/schemes, whether partially or completely, with respect to latency alignment in device collaborative communications in accordance with the present disclosure. The process 700 may represent an aspect of implementation of features of the communication apparatus 510. The process 700 may include one or more operations, actions, or functions as illustrated by one or more of blocks 710, 720, 740, 750 and 760. Although illustrated as discrete blocks, various blocks of the process 700 may be divided into additional blocks, combined into fewer blocks, or eliminated, depending on the desired implementation. Moreover, the blocks of the process 700 may be executed in the order shown in FIG. 7 or, alternatively, in a different order. The process 700 may be implemented by the communication apparatus 510 or any suitable UE or machine type devices. Solely for illustrative purposes and without limitation, the process 700 is described below in the context of the communication apparatus 510. The process 700 may begin at block 710.

At 710, the process 700 may involve the processor 512 of the communication apparatus 510 obtaining information regarding a downlink processing delay of a collaborating communication apparatus (e.g., the relay apparatus 530). The process 700 may proceed from 710 to 720.

At 720, the process 700 may involve the processor 512 determining a downlink latency based on the downlink processing delay. The process 700 may proceed from 720 to 730.

At 730, the process 700 may involve the processor 512 receiving a first RF signal on a first time-frequency resource from a network node (e.g., the network apparatus 520). The first RF signal may carry baseband data generated by the network node. The process 700 may proceed from 730 to 740.

At 740, the process 700 may involve the processor 512 determining a first frame boundary associated with the first RF signal. The process 700 may proceed from 740 to 750.

At 750, the process 700 may involve the processor 512 receiving a second RF signal on a second time-frequency resource from the collaborating communication apparatus. The process 700 may proceed from 750 to 760.

At 760, the process 700 may involve the processor 512 determining a second frame boundary associated with the second RF signal based on the first frame boundary and the downlink latency.

In some implementations, the first time-frequency resource and the second time-frequency resource may not overlap with each other in frequency domain or in time domain.

In some implementations, the process 700 may involve the processor 512 obtaining information regarding an uplink processing delay of the collaborating communication apparatus, transmitting a third RF signal on a third time-frequency resource to the collaborating communication apparatus and transmitting a fourth RF signal on a fourth time-frequency resource to the network node. An uplink latency of the transmitting of the fourth RF signal on the fourth time-frequency resource with respect to the transmitting of the third RF signal on the third time-frequency resource may be determined based on the uplink processing delay.

In some implementations, the third RF signal and the fourth RF signal carry a first baseband data signal and a second baseband data signal respectively, and the first baseband data signal and the second data signal are to be or are supposed to be received by the network node in a same slot.

In some implementations, the third RF signal may be transmitted at a first time, the fourth RF signal may be transmitted at a second time, and wherein the first time is prior to the second time by the uplink latency or by a quantized value of the uplink latency.

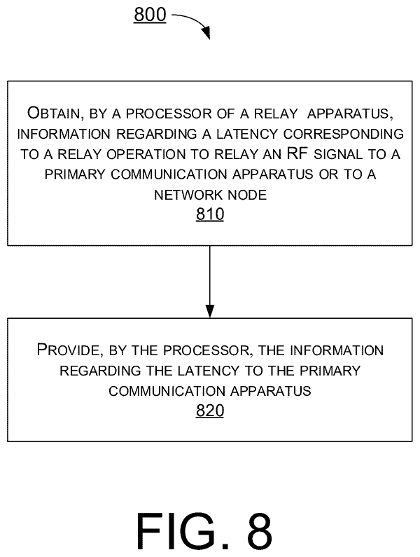

FIG. 8 depicting yet another example process 800 in accordance with an implementation of the present disclosure. The process 800 may be an example implementation of above scenarios/schemes, whether partially or completely, with respect to latency alignment in device collaborative communications in accordance with the present disclosure. The process 800 may represent an aspect of implementation of features of the relay apparatus 530. The process 800 may include one or more operations, actions, or functions as illustrated by one or more of blocks 810 and 820. Although illustrated as discrete blocks, various blocks of the process 800 may be divided into additional blocks, combined into fewer blocks, or eliminated, depending on the desired implementation. Moreover, the blocks of the process 800 may be executed in the order shown in FIG. 8 or, alternatively, in a different order. The process 800 may be implemented by the relay apparatus 530 or any suitable UE or machine type devices. Solely for illustrative purposes and without limitation, the process 800 is described below in the context of the relay apparatus 530. The process 800 may begin at block 810.

At 810, the process 800 may involve the processor 532 of the relay apparatus 530 obtaining information regarding a latency corresponding to a relay operation to relay an RF signal to a primary communication apparatus (e.g., the communication apparatus 510) or to a network node (e.g., the network apparatus 520). The process 800 may proceed from 810 to 820.

At 820, the process 800 may involve the processor 532 providing the information regarding the latency to the primary communication apparatus.

In some implementations, the relay operation may comprise amplifying and forwarding and may not comprise decoding the RF signal. In some implementations, the relay operation may be based on amplifying and forwarding without decoding the RF signal.

In some implementations, the information regarding the latency may be pre-stored in a memory (e.g., the memory 534) of the relay apparatus 530.

In some implementations, the latency may comprise an uplink latency, and the process 800 may involve the processor 532 receiving a first RF signal on a first time-frequency resource from the primary communication apparatus, transmitting a second RF signal on a second time-frequency resource to the network node and determining a time difference between the receiving of the first RF signal on the first time-frequency resource and the transmitting of the second RF signal on the second time-frequency resource as the uplink latency. In some implementations, the first RF signal may carry baseband data generated by the primary communication apparatus and the second RF signal is originated from the first RF signal.

In some implementations, the process 800 may involve the processor 532 translating the first RF signal from a first frequency band corresponding to the first time-frequency resource to a second frequency band corresponding to the second time-frequency resource to generate the second RF signal.

In some implementations, the first time-frequency resource and the second time-frequency resource may not overlap with each other in time domain or in frequency domain.

In some implementations, the latency may comprise a downlink latency, and the process 800 may involve the processor 532 receiving a first RF signal on a first time-frequency resource from the network node, transmitting a second RF signal on a second time-frequency resource to the primary communication apparatus and determining a time difference between the receiving of the first RF signal on the first time-frequency resource and the transmitting of the second RF signal on the second time-frequency resource as the downlink latency.

In some implementations, the process 800 may involve the processor 532 translating the first RF signal from a first frequency band corresponding to the first time-frequency resource to a second frequency band corresponding to the second time-frequency resource to generate the second RF signal.

In some implementations, the first time-frequency resource and the second time-frequency resource may not overlap with each other in time domain or in frequency domain.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
obtaining, by a processor of a collaborating communication apparatus, information regarding a latency corresponding to a relay operation to relay a radio frequency (RF) signal to a primary communication apparatus or to a network node; and
providing, by the processor, the information regarding the latency to the primary communication apparatus.

2. The method of claim 1, wherein the relay operation comprises amplifying and forwarding without decoding the RF signal.

3. The method of claim 1, wherein the information regarding the latency is pre-stored in a memory of the collaborating communication apparatus.

4. The method of claim 1, wherein the latency comprises an uplink latency, and the method further comprises:
receiving, by the processor, a first RF signal on a first time-frequency resource from the primary communication apparatus;
transmitting, by the processor, a second RF signal on a second time-frequency resource to the network node; and
determining, by the processor, a time difference between the receiving of the first RF signal on the first time-frequency resource and the transmitting of the second RF signal on the second time-frequency resource as the uplink latency.

5. The method of claim 4, further comprising:
translating, by the processor, the first RF signal from a first frequency band corresponding to the first time-frequency resource to a second frequency band corresponding to the second time-frequency resource to generate the second RF signal.

6. The method of claim 4, wherein the first time-frequency resource and the second time-frequency resource do not overlap with each other in time domain or in frequency domain.

7. The method of claim 1, wherein the latency comprises a downlink latency, and the method further comprises:
receiving, by the processor, a first RF signal on a first time-frequency resource from the network node;
transmitting, by the processor, a second RF signal on a second time-frequency resource to the primary communication apparatus; and
determining, by the processor, a time difference between the receiving of the first RF signal on the first time-frequency resource and the transmitting of the second RF signal on the second time-frequency resource as the downlink latency.

8. The method of claim 7, further comprising:
translating, by the processor, the first RF signal from a first frequency band corresponding to the first time-frequency resource to a second frequency band corresponding to the second time-frequency resource to generate the second RF signal.

9. The method of claim 7, wherein the first time-frequency resource and the second time-frequency resource do not overlap with each other in time domain or in frequency domain.

10. A method, comprising:
obtaining, by a processor of a primary communication apparatus, information regarding an uplink processing delay of a collaborating communication apparatus;
transmitting, by the processor, a first RF signal on a first time-frequency resource to the collaborating communication apparatus; and
transmitting, by the processor, a second RF signal on a second time-frequency resource to a network node,
wherein an uplink latency of the transmitting of the second RF signal on the second time-frequency resource with respect to the transmitting of the first RF signal on the first time-frequency resource is determined based on the uplink processing delay.

11. The method of claim 10, wherein the first RF signal and the second RF signal carry a first baseband data signal and a second baseband data signal respectively, and wherein the first baseband data signal and the second data signal are to be received by the network node in a same slot.

12. The method of claim 10, wherein the first RF signal is transmitted at a first time, the second RF signal is transmitted at a second time, and wherein the first time is prior to the second time by the uplink latency or by a quantized value of the uplink latency.

13. The method of claim 10, wherein the first time-frequency resource and the second time-frequency resource do not overlap with each other in the time domain or in frequency domain.

14. The method of claim 10, further comprising:
obtaining, by the processor, information regarding a downlink processing delay of the collaborating communication apparatus;
determining, by the processor, a downlink latency based on the downlink processing delay;
receiving, by the processor, a third RF signal on a third time-frequency resource from the network node, wherein the third RF signal carries baseband data;
determining, by the processor, a first frame boundary associated with the third RF signal;
receiving, by the processor, a fourth RF signal on a fourth time-frequency resource from the collaborating communication apparatus; and
determining, by the processor, a second frame boundary associated with the fourth RF signal based on the first frame boundary and the downlink latency.

15. A method, comprising:
obtaining, by a processor of a primary communication apparatus, information regarding a downlink processing delay of a collaborating communication apparatus;
determining, by the processor, a downlink latency based on the downlink processing delay;
receiving, by the processor, a first RF signal on a first time-frequency resource from a network node, wherein the first RF signal carries baseband data;
determining, by the processor, a first frame boundary associated with the first RF signal;
receiving, by the processor, a second RF signal on a second time-frequency resource from the collaborating communication apparatus; and
determining, by the processor, a second frame boundary associated with the second RF signal based on the first frame boundary and the downlink latency.

16. The method of claim 15, wherein the first time-frequency resource and the second time-frequency resource do not overlap with each other in frequency domain or in time domain.

17. The method of claim 15, further comprising:
obtaining, by the processor, information regarding an uplink processing delay of the collaborating communication apparatus;
transmitting, by the processor, a third RF signal on a third time-frequency resource to the collaborating communication apparatus; and
transmitting, by the processor, a fourth RF signal on a fourth time-frequency resource to the network node,
wherein an uplink latency of the transmitting of the fourth RF signal on the fourth time-frequency resource with respect to the transmitting of the third RF signal on the third time-frequency resource is determined based on the uplink processing delay.

18. The method of claim 17, wherein the third RF signal and the fourth RF signal carry a first baseband data signal and a second baseband data signal respectively, and wherein the first baseband data signal and the second data signal are to be received by the network node in a same slot.

19. The method of claim 17, wherein the third RF signal is transmitted at a first time, the fourth RF signal is transmitted at a second time, and wherein the first time is prior to the second time by the uplink latency or by a quantized value of the uplink latency.
